(19) United States
(12) Patent Application Publication
(10) Pub. No.: US 2022/0030340 A1
(43) Pub. Date: Jan. 27, 2022

(54) Voice Amplification System for Disposable PPE Masks

(71) Applicant: CERAMI, INC., New York, NY (US)

(72) Inventors: Virginia Marie Demske, Forest Hills, NY (US); Victoria J. Cerami, Rye, NY (US)

(21) Appl. No.: 17/381,291

(22) Filed: Jul. 21, 2021

Related U.S. Application Data
(60) Provisional application No. 63/055,212, filed on Jul. 22, 2020.

(51) Int. Cl. H04R 1/02; A41D 13/11; H04R 1/04

(52) U.S. Cl. CPC H04R 1/025; H04R 2201/028; H04R 1/04; A41D 13/11

(57) ABSTRACT

A lightweight speaker unit may be attached directly to the filter material of a disposable or washable filter or mask to improve voice communications with those individuals wearing the mask.

### CROSS REFERENCE TO RELATED APPLICATION

This application claims the benefit of U.S. provisional application 63/055,212 filed Jul. 22, 2020, and hereby incorporated by reference.

### BACKGROUND OF THE INVENTION

The present invention relates to respirator masks, for example, used as personal protective equipment (PPE), and in particular for a method of improving communication by individuals wearing disposable respirator masks.

In response to the global pandemic, the United States Centers for Disease Control and Prevention and the World Health Organization recommend people wear masks to reduce the transmission of the novel coronavirus. Disposable pleated types of “surgical masks” and preformed cup-shaped masks of nonwoven material have proven effective in providing good protection through cost-effective replacement after use.

The effective filtration of masks of these types can result in an attenuation of the volume of the user's speaking voice. This attenuation can be a particular problem for individuals who rely heavily on spoken communication during the day such as educators and healthcare workers. In some cases, this may risk voice strain or reduced compliance with mask requirements.

### SUMMARY OF THE INVENTION

The present invention provides a speech amplifier that can be replaceably attached to a disposable or washable mask so as to be removed from that mask to be attached to a new mask from time to time as needed, alleviating the problems of reduced voice volume and intelligibility while preserving the desirable ability to use disposable and washable masks.

In one embodiment, the invention provides a respirator mask providing a filter medium adapted for air filtration with straps communicating with the filter medium to position and hold the filter medium over the mouth and nose of an individual to capture and filter air during respiration by the individual. A microphone/speaker assembly is contained in a housing holding a microphone, a speaker, an amplifier, and a battery, the microphone communicating with the amplifier as powered by the battery to provide an audio signal to the speaker, and a housing support releasably attaches the housing to an outside of the filter media to be wholly supported by the filter media with the microphone positioned proximate to the user's mouth.

It is thus a feature of at least one embodiment of the invention to provide a voice amplification system that may be readily used by a variety of different masks by direct attachment to the filter media for support of the amplification system.

The housing support may provide a first portion attached to the housing and a second portion fitting inside the filter media to clamp the filter media between the first and second portions.

It is thus a feature of at least one embodiment of the invention to provide a robust attachment method that resists dislodgment and may be reused, for example, in contrast to adhesives or the like.

In one embodiment, the housing support may provide at least one shaft piercing the filter media and communicating between the first and second portions.

It is thus a feature of at least one embodiment of the invention to take advantage of the porous nature of filter material to allow direct attachment through physical pins passing through the filter media. A small size of the pins and the ability of the filter media to separate and conform around the pins minimizes any loss of filtration efficiency.

In one embodiment, the first and second housing supports may be magnets polarized to attract each other.

It is thus a feature of at least one embodiment of the invention to eliminate any breach in the filter material

The respiratory mask may further include an equalizer boosting high-frequency audio signals from the microphone prior to receipt by the speaker.

It is thus a feature of at least one embodiment of the invention to permit placement of the microphone outside of the filter material while compensating for the attenuation of higher frequencies caused by the filter material.

In one embodiment, the mask may further include at least one of an automatic gain control circuit adjusting the gain of the signal from the microphone according to an amplitude of the signal from the microphone; a limiter limiting the amplitude of the signal provided to the speaker; and a noise gate suppressing the amplitude of the signal provided to the speaker for signals from the microphone below a predetermined volume.

It is thus a feature of at least one embodiment of the invention to eliminate the need for the user's hands to contact the amplifier unit, for example for volume control adjustment, during normal use.

The housing may further include an LED signaling when the microphone is receiving a signal commensurate with a speaker speaking.

It is thus a feature of at least one embodiment of the invention to provide a visual clue as to the identity of the speaker when the speaker's mouth is covered.

In one embodiment, the mask may include a first housing and a second housing together holding an inter-communicating microphone, a speaker, an amplifier, and a battery, the microphone communicating with the amplifier as powered by the battery to provide an audio signal to the speaker; wherein the microphone is in the first housing and the speaker is in the second housing. Electrically conductive attachment pins sized to pierce the filter media releasably connect the first and second housings, with the first housing inside the filter media and proximate to the user's mouth and the second housing outside of the filter media, the electrically conductive attachment pins providing a communication of electrical signals between the microphone and the speaker.

It is thus a feature of at least one embodiment of the invention to place the microphone inside the filter material close to the user's mouth to eliminate any muffling effects of the filter material.

These particular objects and advantages may apply to only some embodiments falling within the claims and thus do not define the scope of the invention.

### BRIEF DESCRIPTION OF THE DRAWINGS

FIG. 1 is a front elevational view of a mask positioned over a user's face showing the supported speaker unit;

FIG. 2 is an exploded perspective view of a mask and speaker unit showing a first embodiment for attaching the speaker unit to the mask using pins and butterfly clutches;

FIG. 3 is a schematic block diagram of the components of the speaker unit of FIG. 2 showing the contained microphone, speaker, and amplifier unit;

FIG. 4 is a cross-sectional elevational view through the mask of FIG. 2 taken along line 4-4 showing a butterfly clutch mechanism and pin for piercing the mask media to support the speaker unit housing;

FIG. 5 is a figure similar to that of FIG. 4 showing magnetic housing supports supporting the speaker unit housing;

FIG. 6 is a figure similar to that of FIGS. 4 and 5 showing a non-piercing knob and socket attachment for supporting the speaker unit housing;

FIG. 7 is a simplified plan phantom view of a two-part housing incorporating the components of FIG. 3; and

FIG. 8 is a fragmentary cross-sectional side elevational view of a mask showing a clip arrangement for supporting the speaker unit on the mask;

### DETAILED DESCRIPTION OF THE PREFERRED EMBODIMENT

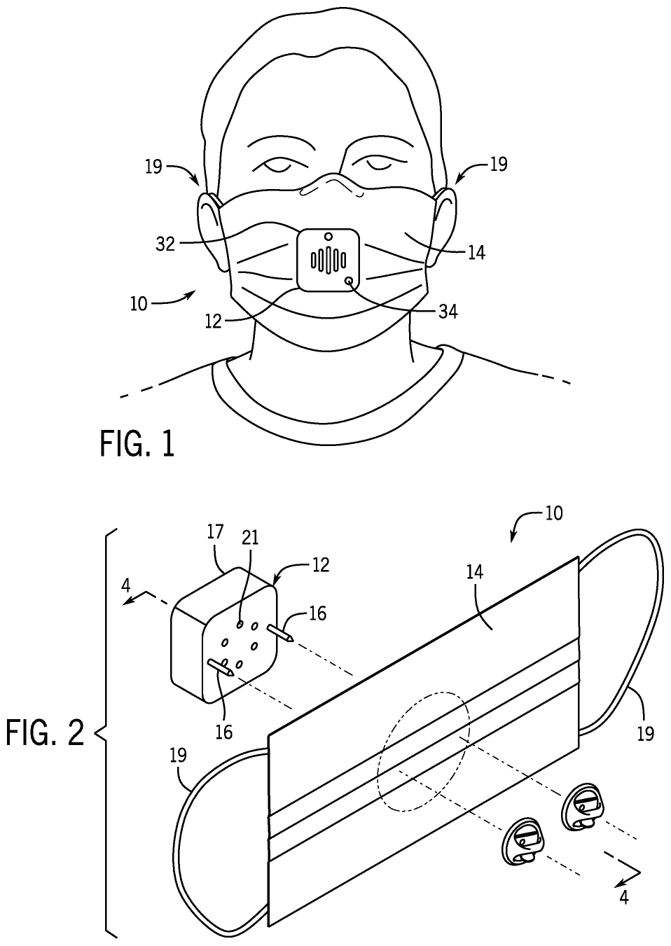

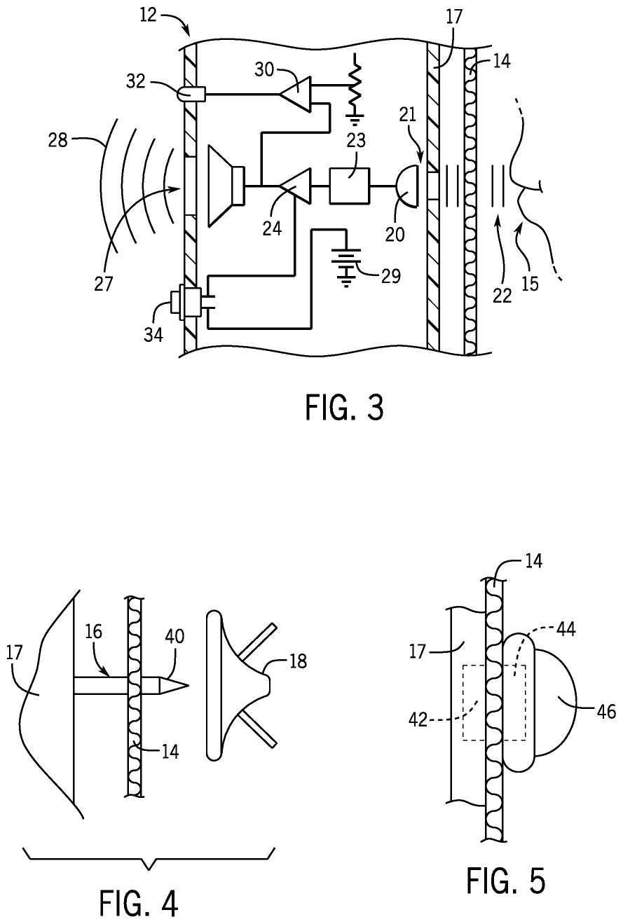

Referring now to FIGS. 1 and 2, in one embodiment, the present invention may provide a respirator mask 10 providing a speaker unit 12 attached to and fully supported by a mask filter material 14. The mask filter material 14 is arranged to be retained over a user's nose and mouth by elastic straps 19 with the speaker unit 12 roughly located in front of the user's mouth 15 (shown in FIG. 3).

In some embodiments, the mask filter material 14 may be a woven or nonwoven material such as meets the requirements as a procedure mask having a particle filtration efficiency under ASTM F2101 for 0.1 micrometer particles of at least 98%. . The mask filter material 14, for example, may have three-ply construction and be pleated to better conform to an individual's nose and mouth. Shell-like structures of filter material are also contemplated. In some embodiments, the mask material may meet the requirements of a medical mask of ASTM F2100 level 1 or better or may satisfy the requirements of N95 masks. In some cases, the filter material may be electrically charged like an electret for improved filtering.

In all cases, the invention contemplates that the mask 10 is a disposable or washable mask where the filter material 14 is sized to be located on and sealingly engage the user's face without ancillary structures such as conforming elastomeric cups or shields. In this regard the mask filter material 14 directly engages the user's face and extends fully between those regions of engagement to comprise over 90% of the material covering the user's face.

The straps 19 may be attached directly to the filter material 14 on either side to provide either loops that may be retained around the user's ears or that may extend fully around the back of the user's head. In this regard the straps 19 may be elastic or may provide for an adjustment, for example, using cinches or the like.

Referring now also to FIG. 3, the speaker unit 12 may provide a housing 17 having a rear surface abutting a front surface of the filter material 14. This rear surface of the housing 17 includes microphone ports 21 to receive acoustic signals 22 from the user's mouth 15. The rear surface of the housing 17 also supports attachment elements 16 (pins as shown) that allow the speaker unit 12 to be releasably attached to and be supported by filter material 14. In this way, the speaker unit 12 may be simply and hygienically moved from a given mask 10 to a new mask after the filter material 14 of a given mask is exhausted. The attachment elements 16 are selected to preserve the integrity of the filter capabilities of the filter material and will be discussed in greater detail below.

Referring to FIG. 3, positioned behind the microphone port of the housing 17 is a microphone 20, for example, an electret microphone, or any similar microphone known in the art, receiving the acoustic signal 22 from the user's mouth 15 to provide a corresponding electrical signal to an audio processor 23. The audio processor 23, for example, may provide for a high-pass filtering to boost high frequencies of the user's voice that would otherwise be muffled by the filter material 14. In addition or alternatively, the audio processor 23 may provide additional signal processing including automatic gain control to automatically adjust the amplitude of the electric signal (and hence the volume of the sound to be produced) to a desired level to prevent over driving or clipping by the subsequent components of the processing chain and to boost the electric signal for individuals with a soft or low speaking voice. In addition, or alternatively, the audio processor 23 may provide a limiter limiting the amplitude of the signal provided to the speaker to below a predetermined level; and/or a noise gate suppressing the amplitude of the signal provided to the speaker for signals from the microphone below a predetermined volume.

An output from the audio processor 23 is provided to an amplifier 24 receiving power from a battery 29 to provide an amplified signal to speaker 26, for example, a piezoelectric or electromagnetic speaker. The speaker 26 in turn produces an output acoustic signal 28 through a set of speaker openings 27 in the housing 17 which may be better heard by individuals communicating with the masked individual.

The output of the amplifier 24 may also be provided to a comparator 30 which provides an electrical signal to a light emitting diode 32 when the signal from the amplifier 24 rises to a level indicating that the user is speaking. This LED 32 thus serves to provide a visual indication of the speaker when an individual's mouth cannot be seen. In one example, the LED may be a bi-color LED that turns turn green if the user is speaking and otherwise turn red.

The invention contemplates that the mask 10 may also provide wireless connectivity, for example, by the use of a Bluetooth transmitter (not shown) communicating with the microphone 20 to allow the user to use the microphone 24 in communication with a portable phone or the like.

Power from the battery 29 to the amplifier 24 and other components may be controlled by a push button switch 34 that may be readily activated by the user, for example, to conserve battery power when the speaker unit 12 is not being employed. A volume control (not shown) may also be provided allowing the user manual control of the volume if desired, for example, using a potentiometer communicating a volume signal to the amplifier 24.

Referring now to FIGS. 2 and 4, in a first embodiment, the attachment elements 16 provide a pair of horizontally spaced sharpened pins 40 extending rearwardly from the housing 17 to pierce the filter material 14 and to be received by corresponding butterfly clutches 18 of a type known in the art. The butterfly clutch 18 may firmly clamp the filter material 14 between a forwardly facing portion of the butterfly clutch 18 and a rearward portion of the housing 17 to minimize air passages through the small perforation made by the pin 40.

Referring now to FIG. 5, in an alternative embodiment the housing 17 may provide a first rare earth magnet 42 polarized to attract a corresponding rare earth magnet 44 in a magnetic backer plate 46 with the filter material 14 tightly clamped between the magnets 42 and 44 but with no perforation of the filter material 14.

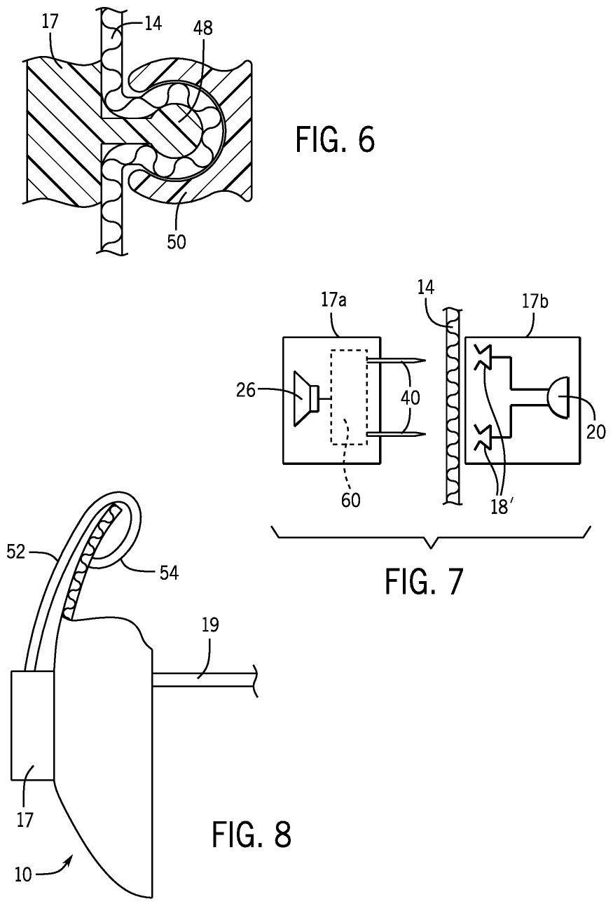

A similar attachment method that does not pierce the filter material 14 is shown in FIG. 6 in which the housing 17 has a rearwardly extending knob 48 about which a portion of filter material 14 may be wrapped to be held by a resilient collar 50 that snaps over the knob 48 and surrounding filter material 14 to hold the two closely together.

Referring now to FIG. 8, in yet another embodiment, a spring hanger clip 52, for example, constructed of flexible resilient wire or polymer may provide an upwardly extending arm from the housing 17 that may follow the curvature of the front of the filter material 14 to fit around an upper edge of the filter material 14 and curve back toward itself to clamp the filter material 14 between a portion of the spring hanger clip 52 on the outside of the filter material 14 and a terminating end 54 of the spring hanger clip 52 on the inside of the filter material 14, again without piercing the filter material and allowing ready replacement.

Referring now to FIG. 17, in an alternative embodiment, the housing 17 may include an outer housing portion 17a and an inner housing portion 17b attachable together on either sides of the filter material 14 with the outer housing 17a being on the outside of the filter material 14 and the inner housing portion 17b being on the inside of the filter material 14 adjacent to the user's mouth. The inner housing 17b may hold the microphone 20 as described above but may be free from interference by the filter material 14 thus eliminating the muffling that may be addressed by the audio processor 23 (shown in FIG. 3). In this case, the pins 40 described with respect to FIG. 4 may be electrically conducting and may communicate signal circuitry 60 (shown in FIG. 3) received from electrically conducting butterfly clutches 18 or similar sockets connected to the microphone 82. The circuitry 60 of housing 17a includes the remaining circuit components of FIG. 3 of the amplifier 24, battery 29, switch 34, speaker 26, comparator 30, and LED 32. Again, the housing 17 (including both portions of 17a and 17b) and its components are fully supported by the filter material and may be replaced as a disposable filter material is changed or removed for washing.

In all cases, the speaker unit 12 will be relatively lightweight so as not to distort or pull down unduly on the filter material 14, for example, having a weight of less than 4 ounces and desirably less than 2 ounces. It will be appreciated that the various electrical components of the amplifier 24 and audio processor 23 may be combined in a single circuit or arbitrarily split among circuits and integrated circuits.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim..

What we claim is:

1. A respirator mask comprising:
a filter medium adapted for air filtration;
straps communicating with the filter medium to position and hold the filter medium over a mouth and nose of an individual to capture and filter air during respiration by the individual;
a microphone/speaker assembly contained in a housing holding a microphone, a speaker, an amplifier, and a battery, the microphone communicating with the amplifier as powered by the battery to provide an audio signal to the speaker; and
a housing support releasably attaching the housing to an outside of the filter media to be wholly supported by the filter media with the microphone positioned proximate to the individual's mouth.

2. The respirator mask of claim 1 wherein the housing support provides a first portion attached to the housing and a second portion fitting inside the filter media to clamp the filter media between the first and second portions.

3. The respirator mask of claim 2 wherein the housing support provides at least one shaft piercing the filter media and communicating between the first and second portions.

4. The respirator mask of claim 2 wherein the first and second housing supports are magnets polarized to attract each other.

5. The respirator mask of claim 1 further including an equalizer boosting high-frequency audio signals from the microphone prior to receipt by the speaker.

6. The respirator mask of claim 1 further includes at least one of: an automatic gain control circuit adjusting the gain of the signal from the microphone according to an amplitude of the signal from the microphone; a limiter limiting the amplitude of the signal provided to the speaker; and a noise gate suppressing the amplitude of the signal provided to the speaker for signals from the microphone below a predetermined volume.

7. The respirator mask of claim 1 wherein the filter medium is adapted to be self-supporting on the individual's nose and mouth by the straps without substantial non-filtering structure.

8. The respirator mask of claim 1 wherein the filter media is a pleated nonwoven material.

9. The respirator mask of claim 1 wherein the housing further includes an LED signaling when the microphone is receiving a signal commensurate with a speaker speaking.

10. A respirator mask comprising:
a filter medium adapted for air filtration;
straps communicating with the filter medium to position and hold the filter medium over the mouth and nose of an individual to capture and filter air during respiration by the individual;
a first housing and a second housing together holding an inter-communicating microphone, a speaker, an amplifier, and a battery, the microphone communicating with the amplifier as powered by the battery to provide an audio signal to the speaker; wherein the microphone is in the first housing and the speaker is in the second housing; and
electrically conductive attachment pins sized to pierce the filter media and releasably connect the first and second housings, with the first housing inside the filter media and proximate to the individual's mouth and the second housing outside of the filter media, the electrically conductive attachment pins providing a communication of electrical signals between the microphone and the speaker.

11. The respirator mask of claim 10 further including an equalizer boosting high-frequency audio signals from the microphone prior to receipt by the speaker.

12. The respirator mask of claim 10 further including an automatic gain control circuit adjusting the gain of the signal from the microphone according to an amplitude of the signal from the microphone.

13. The respirator mask of claim 10 wherein the filter medium is adapted to be self-supporting on the individual's nose and mouth by the straps without substantial non-filtering structure.

14. The respirator mask of claim 10 wherein the filter media is a pleated nonwoven material.

15. The respirator mask of claim 10 wherein the housing further includes an LED signaling when the microphone is receiving a signal commensurate with a speaker speaking.
